(19) United States
(12) Patent Application Publication
(10) Pub. No.: US 2007/0184242 A1
(43) Pub. Date: Aug. 9, 2007

(54) TEAR PROPAGATION-RESISTANT ADHESIVE TAPE

(75) Inventors: Ilse Rodewald, Hamburg (DE); Norbert Grittner, Hamburg (DE); Petra Yun, Hamburg (DE); Michael Rohl, Halstenbek (DE); Siegfried Krupke, Tornesch (DE); Michael Schwertfeger, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, HAMBURG (DE)

(21) Appl. No.: 11/555,800

(22) Filed: Nov. 2, 2006

(30) Foreign Application Priority Data
Nov. 11, 2005 (DE) 10 2005 054 254.9

(51) Int. Cl. B32B 3/10

(52) U.S. Cl. 428/136; 428/354

(57) ABSTRACT

Adhesive tape having a backing material applied to at least one side of which is an adhesive, in particular a pressure-sensitive adhesive, the backing material being composed of a laminate of at least one supporting film and one slitted film, characterized in that the slitted film has at least one slit extending in the machine direction of the adhesive tape.

The invention relates to an adhesive tape whose backing is composed of a laminate of at least two films.

Tear propagation resistance in adhesive tapes poses a problem on which work is continually ongoing to find a solution.

It is known, furthermore, that films which are monoaxially oriented for the purpose of achieving a high machine-direction tensile strength typically have the drawback of a drastically reduced tear propagation resistance.

Solutions for increasing the tear propagation resistance of adhesive tapes are based on a variety of approaches, an example being the fibre reinforcement of the backing material. Typical tapes include what are called “filament” adhesive tapes with unidirectional lengthwise nonwoven scrims or bidirectional woven or nonwoven scrims, composed of twisted or tangled yarns. These yarns may be composed, for example, of continuous synthetic fibres or else of natural fibres. The fibres in this kind of adhesive tape are often held together to form locally fixed fibre or filament bundles.

The fibres introduced in this way, as well as increasing the tear propagation resistance, may take on the provision of a variable component of the tensile strength.

Another solution is, for example, an oriented film composed of at least two coextruded layers of different composition, with an irregular internal structure, as set out in DE 199 55 610 A1. In this arrangement, the thickness of one of these layers varies in inverse proportion to the second layer across the width of the adhesive tape; the overall thickness is constant. As a result of the different mechanical properties of the layers, a tear which begins in the cross direction is diverted into the machine direction. An obvious drawback of the embodiment disclosed therein, however, is the costly and complicated machinery needed to produce this type of film.

A further means of increasing the tear propagation resistance is, for example, a reinforcing rib structure, as is disclosed in EP 0 411 830 A1, EP 0 343 896 A1, U.S. Pat. No. 5,145,544 A and U.S. Pat. No. 5,173,141 A. This variant too has a variety of drawbacks, which have already been set out adequately in DE 199 55 610 A1.

It is an object of the invention to provide an adhesive tape which has a very high tear propagation resistance in cross direction (cd) and a very high tensile strength in machine direction (md).

This object is achieved by means of an adhesive tape as set out in claim 1. The dependent claims provide developments of the adhesive tape of the invention, and also uses thereof.

The invention accordingly provides an adhesive tape having a backing material applied to at least one side of which is an adhesive, in particular a pressure-sensitive adhesive, the backing material being composed of a laminate of at least one supporting film and one slitted film, the slitted film having at least one slit extending in the machine direction of the adhesive tape.

In one first advantageous embodiment the slitted film is located between supporting film and adhesive.

The backing material may have further films, in which case they too may be implemented in the form of further slitted films.

The laminate of the backing material is subject to virtually no restriction in terms of its construction (number of films, thickness and material of the films employed), but can instead be custom-tailored to the prevailing requirements that are imposed on the adhesive tape.

In one preferred embodiment of the backing material two marginal strips are slit into the slitted film. The width of the marginal strips amounts to not more than one-third of the overall adhesive tape width. The marginal strips offer protection against preliminarily calculable side-edge damage with a maximum depth of penetration. The marginal strips may remain in the laminate or be taken off as waste before the tape is wound into rolls.

The supporting film is unslitted and adopts the function of stabilizing the slitted film, in other words of preventing the individual parts of the slitted film from falling apart. Material which can be used for the supporting film includes all of the film materials known to the skilled person, the selection being limited only by the operation used to produce the laminate.

Preference is given, for example, to BOPP, MOPP, PP, PE, PET, PA, PU, PVC or polyesters. Generally speaking it is possible to use polyolefins, copolymers of ethylene and polar monomers such as styrene, vinyl acetate, methyl methacrylate, butyl acrylate or acrylic acid, homopolymers such as HDPE, LDPE, MDPE or copolymers of ethylene and a further olefin such as propene, butene, hexene or octene (for example LLDPE, VLLDPE) or polypropylenes such as, for example, polypropylene homopolymers, random polypropylene copolymers or polypropylene block copolymers.

The film thicknesses may range advantageously from 5 to 50 μm. Even greater thicknesses may be employed, although in that case it should be ensured that the supporting backing substantially ensures the technically necessary disposition of, in particular, the slitted film in the subsequent adhesive tape.

Accordingly the supporting backing film, in the event of the adhesive tape being torn into, is able to tear even completely across the entire width without any substantial detriment to the stability of the adhesive tape.

Besides the function of stabilizing the slitted film, the supporting backing may take on further functions by virtue of an appropriate selection of material.

It may serve as protection against chemicals or as a barrier film, by application of a metallic layer, for example.

It may ensure the UV protection of the adhesive, by virtue of the incorporation of UV absorbers.

It may determine the optical properties, such as gloss or colour, through the use, for example, of a coloured film.

The surface properties, such as friction or release effect, may be decisively influenced.

As well as the options specified here, there are further developments of the supporting foil that are possible, though not explicitly set out here, the actual selection lying within the usual technical knowledge of the skilled person.

The slotted backing takes on the load-bearing function. Here again, all materials are conceivable, though it is preferred to use relatively stiff and high-tensile backings such as PET, MOPP and U-PVC. The slotted backing has at least one slot which extends in the machine direction of the adhesive tape, so that at least one further undamaged film edge is produced in addition to the two side edges.

The slotted film is selected according to mechanical properties such as tensile strength, stiffness, and others.

Like the supporting film, the slotted film may also take on the additional functions recited above, at least partly.

The strips may have different widths. It is particularly preferred, however, for all of the strips to have the same width. As a consequence of the production process, the two outer strips may have deviating widths.

In order to provide additional inner edges by means of the strips, at least two slits are envisaged. In that case the cut edge can be disposed centrally, so that the two strips are of equal width. It is also possible, however, to produce “asymmetrical” slitted films, in which one strip is wider than the second strip and in which, in particular, the tear propagation propensity is reduced from the side of the narrowest strip.

The number of strips can be increased in principle arbitrarily, the upper limit on the number of strips being governed by the width of the adhesive tape and the strip width. Thus it is possible, for example, also to produce symmetrical or asymmetrical slitted films having three strips, examples being those in which one inner edge in each case is provided as a tear boundary in the vicinity of the adhesive tape's edges.

The width of the strips is with particular preference between 1 and 4 mm, very preferably about 2 mm. Particularly in the case of strips which have a low width in relation to the width of the adhesive tape, an equal strip width is of advantage.

Preferred embodiments are those in which there is a slit across the width of the adhesive tape. Moreover, two slits, preferably disposed symmetrically, have proved to be advantageous. Thus a particularly advantageous adhesive tape, with a width of 15 mm, is one in which there is a slitted film with a total of three strips having, from left to right, a width of 4/7/4 mm.

The materials of supporting film and slitted film may be selected independently of one another.

In a further preferred embodiment the laminate of at least the supporting film and the slitted film is formed by the individual layers being joined to one another by means of an adhesive. For this purpose it is possible to use all of the typical adhesives, such as, for example, hotmelt adhesives, pressure-sensitive adhesives or PU-based adhesives. The layer thickness of the adhesive is between 7 to 50 μm. The laminating adhesive used may be coloured.

Alternatively it is also possible to use a heat-seal film, in order to join the at least two films to one another.

The laminate results in a backing material of high strength which in turn permits adhesive tapes which in terms of their thickness are situated well below prior-art adhesive tapes for corresponding fields of use. For instance it is possible to produce adhesive tapes having a thickness of in particular 80 to 150 μm, with particular preference of below 120 μm, with very particular preference of below 100 μm, which, surprisingly, have a comparable tear strength.

The strength of the backing material is preferably at least 250 N/mm², in particular 300 N/mm².

The adhesive tape has a considerable tensile strength and also tear propagation resistance in cross direction. Furthermore, it is of only minimal extensibility, and achieves all of this with a very low thickness.

The adhesive of the adhesive tapes of the invention may be a (self-)adhesive from the group of the natural rubbers or the synthetic rubbers, or composed of any desired blend of natural rubbers and/or synthetic rubbers, it being possible for the natural rubber or rubbers to be selected in principle from all available grades, such as, for example, crepe, RSS, ADS, TSR or CV grades, depending on required purity and viscosity level, and for the synthetic rubber or rubbers to be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible to improve the processing properties of the rubbers by adding thermoplastic elastomers with a weight fraction of 10% to 50% by weight, based on the overall elastomer fraction.

Representatives that may be mentioned at this point include in particular the especially compatible styrene-isoprene-styrene (SIS) and styrene-butadiene-styrene (SBS) grades.

In addition a 100% styrene-isoprene-styrene (SIS) system has proved to be suitable.

Tackifying resins which can be used include, without exception, all tackifier resins already known and described in the literature. Representatives that may be mentioned include the rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Express reference may be made to the exposition of the state of knowledge in the “Handbook of Pressure Sensitive Adhesive Technology” by Donatas Satas (van Nostrand, 1989).

Crosslinking is advantageous for improving the removability of the adhesive tape after the application, and may take place thermally or by irradiation with UV light or electron beams.

For the purpose of thermally induced chemical crosslinking it is possible to employ all known thermally activable chemical crosslinkers, such as accelerated sulphur systems or sulphur donor systems, isocyanate systems, reactive melamine resins, formaldehyde resins and (optionally halogenated) phenol-formaldehyde resins and/or reactive phenolic resin crosslinking systems or diisocyanate crosslinking systems with the corresponding activators, epoxidized polyester resins and acrylate resins, and also combinations of these.

The crosslinkers are activated preferably at temperatures above 50° C., in particular at temperatures of 100° C. to 160° C., very preferably at temperatures of 110° C. to 140° C. The thermal excitation of the crosslinkers may also take place by means of IR rays or high-energy alternating fields.

An adhesive which is suitable is one based on acrylate hotmelt, on solvent or on water, it being possible for the first of these to have a K value of at least 20, in particular more than 30, and it being obtainable by concentrating a solution of such an adhesive to give a system which can be processed as a hotmelt.

Concentration may take place in appropriately equipped tanks or extruders; particularly in the case of accompanying devolatilization, a devolatilizing extruder is preferred.

One such adhesive is set out in DE 43 13 008 A1, whose content is hereby incorporated by reference to be part of this disclosure and invention.

Alternatively the acrylate hotmelt-based adhesive can be chemically crosslinked.

In one further embodiment the self-adhesives used are copolymers of (meth)acrylic acid and the esters thereof having 1 to 25 C atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers.

The residual solvent content ought to be below 1% by weight.

One adhesive which is found to be particularly suitable is a low molecular mass acrylate hotmelt pressure-sensitive adhesive of the kind carried under the name acResin UV or Acronal®, especially Acronal® DS3458, by BASF. This low-K-value adhesive acquires its application-compatible properties by means of a concluding, radiation-induced chemical crosslinking.

Finally it may be mentioned that polyurethane-based adhesives are also suitable.

A single-sidedly adhesive tape may be used for particular advantage, the application of adhesive being preferably between 15 to 60 g/m², with further preference between 20 to 30 g/m².

The adhesive tape, finally, may have a liner material, with which the one or two layers of adhesive are lined until use. Suitable liner materials include all of the materials listed in detail above.

Preference, however, is given to using a non-fluffing material such as a polymeric film or a well-sized, long-fibred paper.

That side of the adhesive tape which is not furnished with adhesive, if appropriate, may then carry typical primers.

The slitting of the slitted film may take place at various points in the production operation, for example prior to the production of the laminate. For this purpose the film to be slitted is guided, for example, past a set of blades, slit into strips and subsequently laminated directly to the supporting film. Slitting need not necessarily take place by blade cutting; instead, slitting may also take place with other commercially customary cutting methods.

Which of the two backings carries the laminating adhesive prior to lamination is not critical. The slitted backing can also be coated even at this stage with the subsequent pressure-sensitive adhesive.

A second variant of the slitting operation takes place after the production of laminate and in the operating step of conversion (cutting of the adhesive tape to the desired width). For this case a laminate of supporting backing and slitted backing is produced and is coated with the preferred pressure-sensitive adhesive. This laminate is subsequently subjected to rotary diecutting. In this case the laminate is cut right through in the desired adhesive tape width and in between is kiss-cut at least once, so that the slitted backing lying upwards beneath the rotary die is cut through, the laminating adhesive used is utilized as a buffer zone, and the lowermost supporting backing is undamaged.

The conventional applications of adhesive tapes with tear propagation resistance encompass, for example, bundling, packing, palletizing or use similar to a tensioning belt, and are described at length in U.S. Pat. No. 2,750,315 A. They share the feature of the fixing of one or more articles to itself or themselves, to one another or to further objects.

All of the applications mentioned there can be fulfilled with similar efficiency by the present invention.

Besides the applications specified above, the adhesive tape of the invention is outstandingly suitable for all functions requiring a reinforcing effect of load-bearing elements in combination or, optionally, individually with tear resistance and tear propagation resistance.

Materials which can be reinforced include, for example, those such as paper, corrugated board or solid board, preferably at exposed positions such as grips, handles and cutouts. In addition, the adhesive tape can be used as a constructional element, in order to prevent relatively heavy packages from becoming floppy.

This produces advantages such as
the upgrading of packaging for greater challenges,
a reduction in the total amount of material used, as a result of deliberate strengthening of the zones of principal loading, and
an increase in the useful life of packaging.

In contrast to the known solutions, the present invention does not require any reinforcing filaments.

The present invention is based on the observation that films with undamaged side edges, in other words, for example, clean-cut film strips, do not tear even under tensile load, but instead absorb the tension and convert it into plastic deformation. The strip becomes extended. However, stiff, thin films such as MOPP or PET react immediately by tearing through as soon as the side edge is damaged. In that case it is possible for just an unclean cut or simply just a scratch to constitute damage of this kind which leads to total failure of the adhesive tape under tensile load.

If, however, a number of these edges are produced in an adhesive tape across the width of the backing, then one can be damaged without the adhesive tape tearing right through crossways. The tear is brought to a hold by the next undamaged cut edge.

In the backing material there are preferably a number of slits disposed in parallel with one another. In the case of damage in the marginal region, the tear stops immediately at the next edge produced by the slit, in other words in the direct vicinity of the original end of the tear (the depth of damage corresponds to the ultimate depth of tear).

In the present invention, in the event of lateral damage, one of the edges located further in the interior of the adhesive tape replaces the damaged outer edge and so places the adhesive tape back into a state in which it is undamaged, as it were, for the rest of the remaining, load-bearing width.

The invention therefore relates to the concept that a laminate composed of an unslitted film and a longitudinally slitted film offers the advantages of increased cross-direction tear strength but combines them with the advantages of the film-backed adhesive tapes, such as flat and even structure and low density in conjunction with high tensile strength.

Further advantages of this invention include the fact that films are used. In contrast to filament-reinforced adhesive tapes, for example, this leads to very flat constructions of 100 μm or less for similar performance. Moreover, there are no cavities formed, as in the case of woven and nonwoven scrims, which must be filled up with adhesive. This leads to a succinct saving in terms of adhesive.

The figures described below are used to elucidate the invention in more detail, without any intention to restrict it unnecessarily as a result.

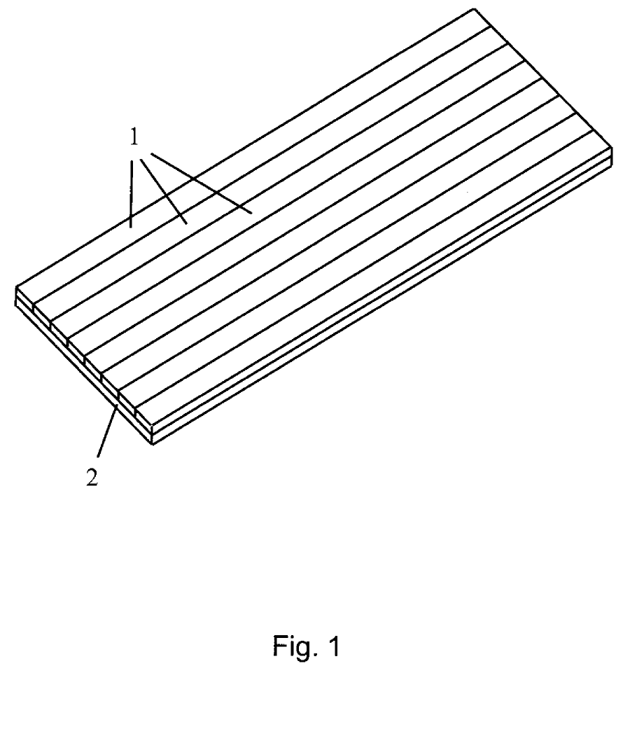

FIG. 1 shows the adhesive tape, looking towards the slitted film;

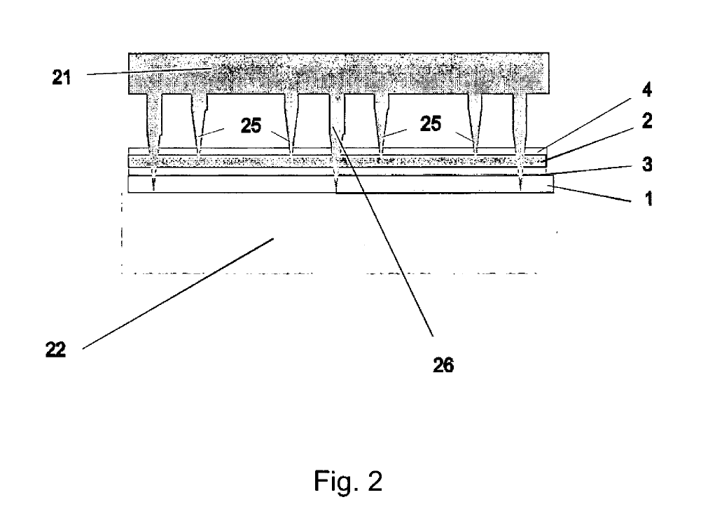

FIG. 2 shows the slitting method for producing the adhesive tape; and

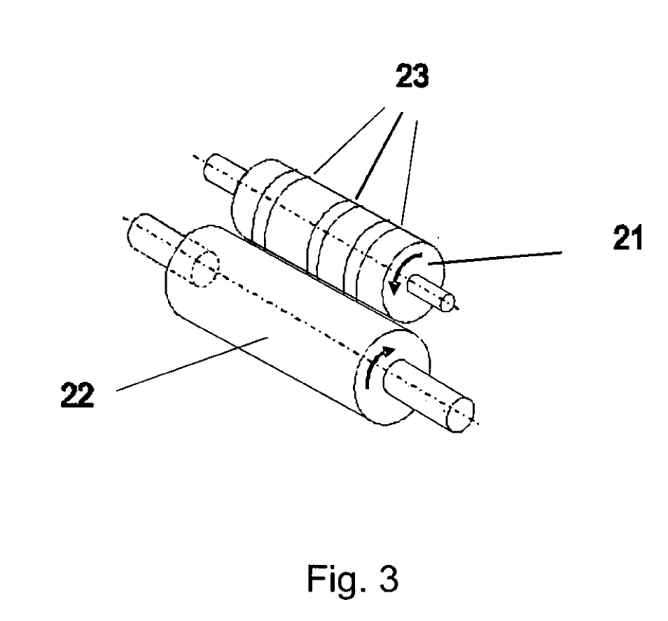

FIG. 3 shows the plant components needed for implementing the slitting method.

The adhesive tape has a backing material which is composed of a laminate of at least one supporting film 2 and of a slitted film formed from a number of strips 1. The strips 1 come about as a result of the slitted film being slit by a number of slits which extend in the machine direction of the adhesive tape.

The adhesive, which is not shown here, is applied to the slitted film.

FIG. 2 shows the slitting method for producing the adhesive tape. The adhesive tape is composed of the four layers of supporting film 1, laminating adhesive 2, slitted film 3 and adhesive 4, and is guided between a rotary cutting shaft 21 and a cutting counter-cylinder 22.

Revolving cutting lines 23 (see FIG. 3) ensure on the one hand that the slitted film 2 is slit, by virtue of the adhesive tape being only kiss-cut (25); in other words, the slitted film 2 is slit and the supporting film 1 remains untouched. The laminating adhesive 3 is utilized as a buffer zone, and the lowermost supporting backing 1 is undamaged.

At the same time the adhesive tape is cut to width, by virtue of all the backing films and also the adhesives being cut through.

FIG. 3 shows, again, the interplay of rotary cutting shaft 21 and cutting counter-cylinder 22.

1. Adhesive tape comprising a backing material and an adhesive applied to at least one side of the backing material, the backing material comprising a laminate of at least one supporting film and one slitted film, wherein the slitted film has at least one slit extending in a machine direction of the adhesive tape.

2. Adhesive tape according to claim 1, wherein the slitted film is located between the supporting film and the adhesive.

3. Adhesive tape according to claim 1, wherein the backing material comprises one or more further films which may also be in the form of slitted film.

4. Adhesive tape according to claim 1, wherein the laminate of at least the supporting film and the slitted film is held together by an adhesive.

5. Adhesive tape according to claim 1, wherein the supporting film is composed of BOPP, MOPP, PP, PE, PET, PA, PU, PVC or polyester and/or has a thickness of 5 to 50 pm.

6. Adhesive tape according to claim 1, wherein the slitted film is composed of polyesters, 25 PET, MOPP or U-PVC.

7. Adhesive tape according to claim 1, wherein the supporting backing has a thickness of up to 50 pm.

8. Adhesive tape according to claim 1, wherein the application of adhesive to the backing material amounts to between 15 to 60 g/m².

9. Adhesive tape according to claim 1, wherein the strength of the backing material is at least 250 N/mm².

10. A method for bundling, packing or palletizing which comprises bundling, packing or palletinzing with an adhesive tape according to claim 1.

11. A method of reinforcing paper, corrugated board or solid board comprising applying an adhesive tape according to claim 1 to said paper, corrugated board or solid board.
